(19) United States
(12) Patent Application Publication
(10) Pub. No.: US 2016/0052632 A1
(43) Pub. Date: Feb. 25, 2016

(54) AIRCRAFT PASSENGER CABIN INTERIOR LAYOUT

(71) Applicant: YASAVA SOLUTIONS SA, Pully (CH)

(72) Inventor: Christopher MBANEFO, Pully (CH)

(73) Assignee: YASAVA SOLUTIONS SA, Pully (CH)

(21) Appl. No.: 14/779,252

(22) PCT Filed: Mar. 22, 2013
(86) PCT No.: PCT/IB2013/052305

§ 371 Date: Sep. 22, 2015

(51) Int. Cl. B64D 11/06; B64D 11/02

(52) U.S. Cl. CPC B64D 11/0601; B64D 11/02

(57) ABSTRACT

An interior configuration of a corporate aircraft, comprises an entrance compartment (100), which is situated directly next to a cockpit (C) of the aircraft, passenger compartment (200) which is adjacent to the entrance compartment (100) opposite to the cockpit (C), an en suite lavatory compartment (300) which is adjacent to the passenger compartment (200) opposite to the entrance compartment (100). The passenger compartment (200) further comprises a first functional area (210) which is adjacent to the entrance compartment (100), is used as a support staff cabin, and comprises at least one seat (S) in a first seat row arrangement (A1), a second functional area (220) which is next to the first functional area (210), is used as a high-end cabin, wherein the second functional area (220) is configurable from at least a first configuration to at least a second configuration, and a first bulkhead divider (B1) between the first functional area (210) and the second functional area (220) which comprises a first pocket door (P1) and first mounting means for allowing the first pocket door (P1) to move between an open and a closed position.

This application is the U.S. national phase of International Application No. PCT/IB2013/052305 filed 22 Mar. 2013 which designated the U.S., the entire content of which is hereby incorporated by reference.

### TECHNICAL FIELD

The present invention relates to interior configurations of corporate aircraft, specifically, to the plan layout of various elements within a corporate aircraft.

### BACKGROUND

Corporate aircraft are typically categorized as follows:

| | | Number of ‘Cab- |
|---|---|---|
| Categories | Sample Model | ins’ or ‘Areas’ |
| Very Light | Cessna Mustang | 1 |
| Light | Learjet 31 | 1 |
| Medium | Learjet 60 | 1 |
| Large | Challenger 605 | 2 |
| Very Large | Challenger 850 | 3 |
| | Legacy | 3 |
| Long Range/Very Large/ | Gulfstream G550, G650 | 3 to 4 |
| Ultra-Long Range | Global XRS, G6000, | |
| | G7000, G8000 | |
| | Falcon 7x, 900, 9x | |

In the three last categories, i.e., Very Large, Long Range/Very Large and Ultra-Long-Range, the typical range of cabin dimensions is:
Cabin Length: 11.92 m (39.10 ft) to 18.30 m (60.00 ft)
Cabin Width: 2.10 m (06.90 ft) to 2.59 m (8.50 ft)
Cabin Height: 1.85 m (06.08 ft) to 1.95 m (6.40 ft)

In these three last categories, the standard interior configuration for all aircrafts in these classes and dimensions are the same, as represented in FIGS. 1 and 2, namely as follows:

Entrance Compartment

The entrance compartment 100 typically has an entrance door D1 on the left hand side of the aircraft. In this area there typically is a galley G on the right hand side. The area is typically separated from the passenger compartment 200 by an entrance bulkhead divider B0 which most often contains a pocket door P0, which slides into the entrance bulkhead divider B0 when open. It is from there that access is gained into the passenger compartment 200. On the opposite end, front end, one has access into the cockpit C, which may or may not be separated by a door.

On the Ultra-Long-Range aircraft, a crew rest area R is located to provide a space for a third pilot. This is typically on the opposite side of the galley G.

On the Ultra-Long-Range aircraft, a toilet W may be positioned in the entrance compartment 100. This is typically for the crew or as a back-up toilet for the passengers, in case of any fault with the passenger's toilet.

Different layout variations are known, such as:
the gallery G and the crew rest area R may be switched, i.e. left and right;
the toilet W and the gallery G may be switched, i.e. forward and aft;
the toilet W and the crew rest area R may be on the same side, typically on the right hand side, with position the gallery G on the left hand side, and vice versa.

Passenger Compartment

The passenger compartment is usually divided into functional areas:

Club Four 10

This area normally has four seats S. The seats S typically have limited movement (forward and aft, inboard and outboard, swivel). Although they are often berthable to full flat, they cannot be used as a bed individually. Hence, two seats S are typically combined to form a bed. This means that two single bed positions are typically possible in this area.

Conference Area 20

This area typically has two pairs of seats S facing each other, located around a permanent table T. This interior configuration is also known as a ‘conference area’. In the original depiction of this area, a single seat S is shown in conjunction with some cabinets. This is known as a ‘workstation’, and typically houses a printer or other office equipment beneath a worktop. The workstation can be rear facing or forward facing. If no workstation is desired on the opposite side, depending on space, there can be a variation of low level (up to below the window level) cabinets, typically known as ‘credenza’.

Variations can include changing the position from the left hand side to right hand side of the cabin. One or two single chairs can be placed on the opposite side, facing each other. Another option can be to replace the single chairs by a divan or sofa on the opposite side.

Aft State Room 30

Typically, a berthable sofa S2, known as divan is placed opposite one or two single seats S. A typical variation may be to have two sofas facing each other. The sofas can be extended in width to make a wider bedding area. Individually, they are insufficient for two persons. In order to utilize as a double bed, two sofas have to be combined. However, in this case there is no space to walk in this area, and access to the aft lavatory is restricted by crawling on the ‘bed’. Access to this area is often by way of a pocket door through a bulkhead divider. There are various designs of bulkheads dividers, with or without a pocket door. Variations include a bulkhead divider that may not span the entire cabin width. Some clients prefer not to have a bulkhead divider but to have an open space configuration of the interior.

The interior configurations described in these areas can be placed in any of the other areas. The variations of interior configurations are thus limited by the possible options described above.

In extra-long cabins, anyone of the areas may be duplicated, resulting in a four cabin configurations.

These typical interior configurations started becoming popular with the Gulfstream G1 aircraft, a turboprop aircraft designed by Grumman Gulfstream Corporation in the US in the early 1960s. This aircraft was changed into a jet aircraft, utilising the same fuselage. Based on North American corporate requirements, a typical executive interior emerged, that is still the norm today and used by all manufacturers of aircraft in the designated categories.

This is acceptable for a typical ‘classless’ group of passengers. All the seats S are essentially the same, everyone uses the same toilet and everyone is within earshot of each other, so there is no distinct privacy.

The different functional areas may or may not be divided by a ‘cabin divider’, a curtain, or a bulkhead divider with or without a pocket door.

In all the sitting areas, single seats and sofas are typically certified for take-off and landing, the total number then being equal to the total number passengers the aircraft may carry. It is the aim of the manufacturer to be able to claim the maximum number of passengers possible. This is also desirable for an owner or operator who wants to use the aircraft for charter to generate revenue.

Consider the following facts:
The average number of passengers in this class of aircraft is between 3 and 4, this means that on average, there are more empty seats than occupied seats.
The average flight duration is less than 3 hours. This means that the permanently installed crew rest area R on the Ultra-Long-Range aircraft is seldom used for a third cockpit crew. From a practical point of view, it is used by the cabin crew to store baggage, coats or other items that cannot be placed in the cabin.
The typical seats are less comfortable than a first class seat on a modern long range airliner.
With the exception of a passenger sleeping on a berthable sofa, the sleeping arrangements in this class of aircraft are ergonomically less comfortable than on a first class seat of a modern long range airliner.
There is no sleeping privacy for the passengers sharing a cabin.
On long flights, a passenger may want a change of environment, including a change of seating positions. In these typical interior configurations, the passenger can often only change a seat, or go from a seat to a sofa. However, the general environment remains the same.

It is the aim of this invention to propose a novel way to define the interior configuration of a corporate aircraft, and to answer to the above mentioned issues.

### SUMMARY OF THE INVENTION

In a first aspect, the invention provides an interior configuration of a corporate aircraft, comprising an entrance compartment, which is situated directly next to a cockpit of the aircraft. The invention further comprises a passenger compartment, adjacent to the entrance compartment opposite to the cockpit and an en suite lavatory compartment, adjacent to the passenger compartment and opposite to the entrance compartment. The passenger compartment further comprises a first functional area, adjacent to the entrance compartment, which is used as a support staff cabin, and comprises at least one seat in a first seat row arrangement. The passenger compartment further comprises a second functional area, next to the first functional area, which is used as a high-end cabin. The second functional area is configurable from at least a first configuration to at least a second configuration. A first bulkhead divider is positioned between the first functional area and the second functional area and comprises a first pocket door and first mounting means for allowing the first pocket door to move between an open and a closed position.

In a first preferred embodiment, the interior configuration of the first functional area comprises the first seat row arrangement which comprises a gangway and additional seats arranged in a configuration selected in the following: one plus one, two plus one, two plus two and three plus one seats.

In a second preferred embodiment, the first functional area of the interior configuration comprises a second seat row arrangement. The seats in the second row are arranged behind the at least one seat and the additional seats.

In a third preferred embodiment, the second functional area of the interior configuration of any comprises a versatile high-end passenger compartment. The versatile high-end passenger compartment further comprises at least one first seat, which is certified for take-off and landing and at least one second seat which is not certified for take-off and landing. The versatile high-end passenger compartment further comprises a private compartment and a second bulkhead divider, which is positioned between the versatile high-end passenger compartment and the private compartment and defines a doorway for passage of people.

In a fourth preferred embodiment, the at least one first seat certified for take-off and landing is fully berthable.

In a fifth preferred embodiment, the at least one first seat certified for take-off and landing comprises means for enabling displacement so that the at least one first seat can be shifted from a first position into at least a second position.

In a sixth preferred embodiment, the interior configuration further comprises a table (T) which is fixed with fixation means so that the versatile high-end passenger compartment (220) can be used as a conference or a dining area.

In a seventh preferred embodiment, the private compartment (230) comprises a convertible sofa positioned at a predetermined angle, comprised between 5° and 45°, from the direction of flight.

In an eighth preferred embodiment, the private compartment (230) comprises at least two fully berthable multi-function seats positioned next to each other at a predetermined angle, comprised between 5° and 45°, from the direction of flight.

In a ninth preferred embodiment, the private compartment (230) further comprises a single seat (Sₓ) with swivel means.

In a tenth preferred embodiment, the single seat (Sₓ) is arranged substantially perpendicular to the longitudinal axis of the corporate aircraft.

In a eleventh preferred embodiment, the private compartment (230) further comprises inflight entertainment systems (I).

In a twelfth preferred embodiment, the private compartment (230) further comprises a full height wardrobe (H).

In a thirteenth preferred embodiment, the second bulkhead divider (B2) comprises a first frame (F1), which accommodates a second pocket door (P2), with second mounting means for allowing the second pocket door (P2) to move between an open and a closed position and at least one second frame (F2), each of which are positioned next to the first frame (F1) and enclose at least one panel.

In a fourteenth preferred embodiment, the at least one second frame (F2) further comprises a plurality of blades. One of the at least one second frame (F2) supports a plurality of blades and fixation means arranged to mount the plurality of blades onto the one of the at least one second frame (F2).

In a fifteenth preferred embodiment, at least a spindle is fixed to and extending beyond the at least one of the plurality of blades (220) at opposite ends thereof The spindle at one end of each blade is fixed with the fixation means onto the at least one delimiting frame (210).

In a sixteenth preferred embodiment, the at least one second frame (F2) encloses at least one perforated panel.

In a seventeenth preferred embodiment, the first frame (F1), the at least one second frame (F2) and the second pocket door (P2) are curved.

In a second aspect, the invention provides a crew rest area (R) configurable from at least a first disposition to at least a second disposition. In the first disposition, a berthable seat, a foldable table, modern appliances and light fixtures are fitted so that this area is used as a crew rest. In the at least a second disposition, the space is organized into a wardrobe/storage volume with wardrobe/storage accessories.

In a eighteenth preferred embodiment, the crew rest area (R) is further configurable into a third disposition, wherein a space is organized to position and store airliner type trolleys, cabinets for additional equipment as may be needed from time to time, depending on operational requirements.

In a nineteenth preferred embodiment, the crew rest area (R) further comprises quick-change fixation means that are configured to easily fit or unfit the berthable seat, the foldable table, the modern appliances and the light fixtures or the wardrobe/storage accessories in the crew rest area (R).

In a twentieth preferred embodiment, the entrance compartment (100) comprises a crew rest area (R).

In a twenty-first preferred embodiment, an en suite lavatory compartment (300) comprises a toilet (W) and

a washbasin with water taps. The en suite lavatory compartment (300) further comprises a full size shower (L) and an access door (D2) so that direct access to a luggage compartment is granted.

In a twenty-second preferred embodiment, the interior configuration comprises the en suite lavatory compartment (300).

In a third aspect, the invention provides an aircraft comprising the interior configuration.

### BRIEF DESCRIPTION OF THE DRAWING

The invention will now be explained through the description of preferred embodiments while referring to figures, as listed herein below:

FIG. 1 illustrates the standard interior configuration according to the prior art,

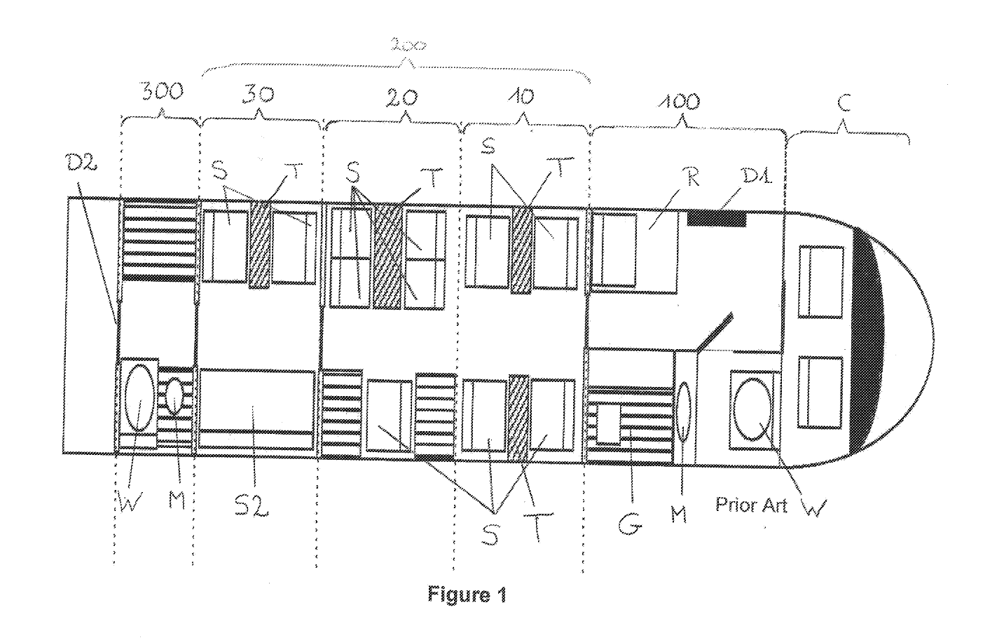

FIG. 2 illustrates the standard configuration options of the conference area in a passenger compartment, according to prior art,

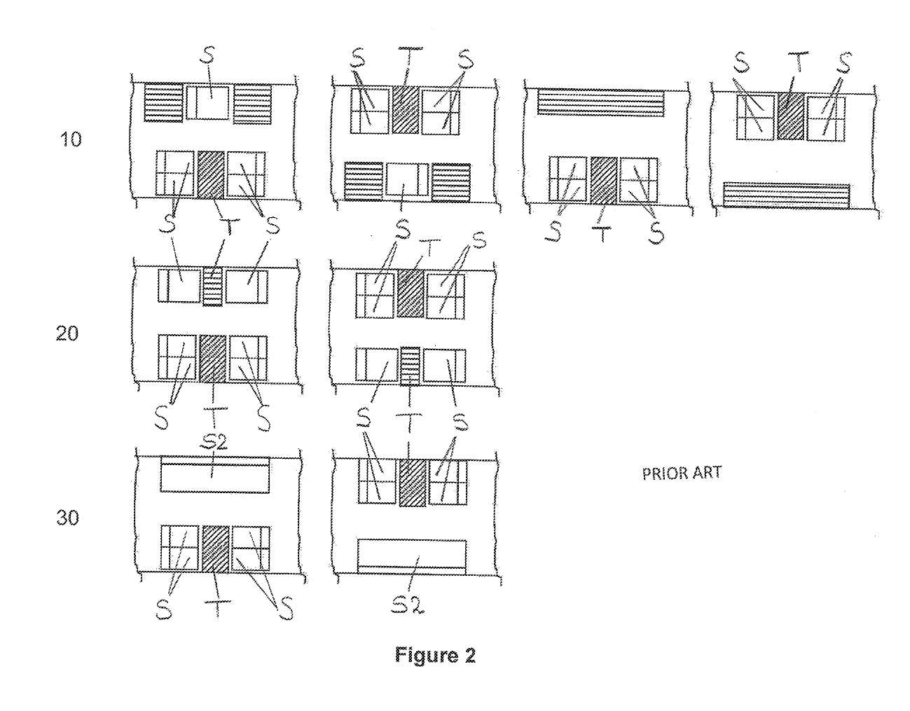

FIG. 3 illustrates a first example of realisation, Executive VI+4R,

FIG. 4 illustrates a second example of realisation, Executive VI+4L,

FIG. 5 illustrates a third example of realisation, Executive IV+3,

FIG. 6 illustrates a fourth example of realisation, Executive IV+6,

FIG. 7 illustrates a fifth example of realisation, Executive IV+6

FIG. 8 illustrates a seventh example of realisation, Executive IV curve+4

FIG. 9 illustrates a eights example of realisation, Executive IV+4,

FIG. 10 illustrates a ninth example of realisation, Executive II+4.

Same reference numbers will be used to refer to similar features that appear in throughout the figures.

### DETAILED DESCRIPTION OF PREFERRED EMBODIMENTS

It is to be understood that the plan layouts described below are only examples of possible realisations of this invention.

General Presentation of Different Functional Areas

Entrance Compartment

The crew rest area R is redesigned to also be a storage area for baggage and/or coats/jackets. Depending on the operational requirements, the user can thus select and choose the usage of this space.

For a long flight, the user can use it as a crew rest.

For shorter flights, which by statistics are the majority of the time, the space can be used as a wardrobe for storing carry-on baggage and coats/jackets. The quick-change system, allows a technician to re-configure the space within a short time. This has never been offered as an option for this category of aircraft. The idea is to use quick disconnect fasteners to attach or disconnect the seat S, as well as the internal wardrobe fixtures. Designated electrical ports are positioned for power and/or entertainment systems, including reading lights, when used as a crew rest. These are covered and/or stowed when used as wardrobe. The entire access can be closed off to provide peace and quiet for the crew, and/or to secure access to the wardrobe, through an acoustic curtain and/or sliding door.

The layout of the crew rest area R is changed from a permanent fixture to variable fixture by way of a quick-change ability to transform it into a wardrobe/storage volume. This allows an operator to use it as a storage facility for flights where a third pilot is not needed. In a situation where a third pilot is needed, the operator can quickly reconfigure the volume from a wardrobe/storage volume into a crew rest area R. This change can be performed by ground crew usually in less than 60 minutes.

Advantageously, the layout of the crew rest area R can also be reconfigured into a third disposition, wherein the crew rest area R is organized to position and store airliner type trolleys, cabinets for additional equipment as may be needed from time to time, depending on operational requirements.

First Functional Srea 210—Staff Cabin

This area is reduced in size and designated as a ‘staff cabin’. It is thus designated for use by passengers who do not normally share the same priority of importance as the owner/client. These could be administrative assistants, security staff or others. The seats S used in this area are not the typical seats used in this class of aircraft. The novel approach is to use seats that are typically used in airline transport aircraft, i.e., economy or business class seats.

This area is accessed by way of two pocket doors (P0 and P1) in two bulkheads (B0 and B1), to/from the entrance compartment 100 and to/from the high-end passenger compartment 200.

Second Functional Area 220

This area is typically enlarged and is designed to accommodate the very important passengers. It may be divided into two zones depending on the number of very important passengers it is designed for.

Furthermore, the novel approach is to have two types of seats or sofas one certified for take-off & landing, the other not certified for take-off & landing. The max number of passengers that can occupy this second functional area 220 during take-off & landing is equal to the number of seats certified for take-off & landing.

The second functional area 220 is typically a high-end passenger compartment which has at least two zones, and leading to the private compartment 230.

High-end passenger compartment 220

First Zone 2201

In the first zone 2201, the take-off/landing certified seats would typically be multi-function seats, such as for example aïana® seats, i.e., seats that are fully berthable and can be utilised individually as a full bed. This zone is designed for the following usage:
take-off and landing;
conferencing/working;
dining.

Second Zone 2202

The second zone 2202, depending on if there is enough space left, is designed for relaxation. It is laid out as a communal zone for social interaction and activities such as watching film/TV, listening to music, chatting, playing or other social interaction. It typically has a combination of different size sofas, lounge furniture, and cabinets, all depending on the preferences and requirements of the very important client. This zone typically is not occupied during take-off and landing.

The second zone 2202 is adjacent to the private compartment 230, and is separated from the private compartment 230 in a novel way:
a first frame F1;
a second pocket door P2 that slides into the first frame F1;
a second frame F2 shaping with the first frame F1 a second bulkhead divider B2 with variable visual penetration. The method employed is for example a vertical louvre design in which the individual blades are rotated in unison from full open to full close.

This allows to visually increase the space of the versatile high-end passenger compartment 220 during daytime use, when both the versatile high-end passenger compartment 220 and the private compartment 230 can be used in unison. However the versatile high-end passenger compartment 220 can be fully separated from the private compartment 230 by rotating the blades closed and shutting the door.

A further variation is to have a curved separation between the versatile high-end passenger compartment 220 and the private compartment 230. This is achieved in a novel way:
a first curved frame F1c a curved second pocket door P2 that slides into the a first curved frame F1c
a second curved frame F2c with variable visual penetration. The method employed is for example a vertical louvre design in which the individual blades are rotated in unison from full open to full closed.

The first frame F1 and/or the second frame F2 can support aperture wall, claustra, moucharaby, blade/louvre structure, controlled-occultation glass or any other adapted material so that the dual functions of both privacy protection and light transmission can be realized.

Private Compartment 230

This area is designed as a private area with a dual function, day and night.

Daytime: The area consists of a sofa, angled at a predetermined degree. The sofa can sit two persons comfortably. Adjacent to the sofa is a single seat Sₓ that can be folded away when not in use. When in use, it is a comfortable and stylish seat Sₓ, complementary in design and finish. It can be folded away into the adjacent cabinet next to the sofa. The single seat Sₓ is positioned at a 90 degrees angle to the direction of flight, facing inboard, and/or can be rotated/swivelled through a range of degrees to facilitate interaction with those persons on the sofa. Opposite the sofa is an angled cabinet, squarely facing the sofa that can house items depending on the requirements of the very important client. This can for example be
a large TV entertainment system, and/or
a HiFi sound entertainment system, and/or
a wall library, and/or
any display of visual art objects, and/or
a bar/drinks/vinothek display, and/or
an additional wardrobe cabinet.

Night-time: The sofa is transformed from a two-seater into a double bed. Depending on the design of the opposite cabinet, there may still be space to walk around the bed. Typically, the second pocket door P2 and the louvres facing the versatile high-end passenger compartment 220 would be closed, respectively rotated shut, resulting in a fully private cabin. There is also a full height wardrobe H in this area for the very important passenger(s). Access to the private lavatory is easy, as well as access to the second pocket door P2 leading to the versatile high-end passenger compartment 220.

At night the single seat Sₓ can be used or stowed away. At night it is envisioned it could be used by a night nurse for medical supervision. It can also be used as a seat, and thus as an alternative to sitting on the bed, if desired.

In another embodiment, the sofa is replaced by two multi-function seats placed next to each other, such as for example aïana® seats, i.e., seats that are fully berthable and can be utilised individually as a full bed. This configuration allows to vary the positions of each seat, either individually, or in unison from the upright position, through the relax position to the bedding position. In the bedding position a full bed is made available.

En Suite Lavatory Compartment 300

The layout of the lavatory is changed by not placing the toilet W at an angle. The toilet W is placed 90 degree to the direction of flight, directly facing the washbasin M and water taps.

Furthermore, the access door D2 to the baggage compartment, is offset to the left hand side and is no longer along the aircraft centre line. It will thus be reduced in height due to the curvature of the cabin ceiling. This is taken as acceptable, given that this access door D2 is not the prime access to the baggage hold for loading baggage. Furthermore, it can still be readily accessed if needed. This results in an increased space for a full sized shower L. The novelty of this arrangement is that access to the baggage hold is no longer through the shower L.

### Description of Example Interior Layouts (Designs)

Realisation 1—Executive VI+4R

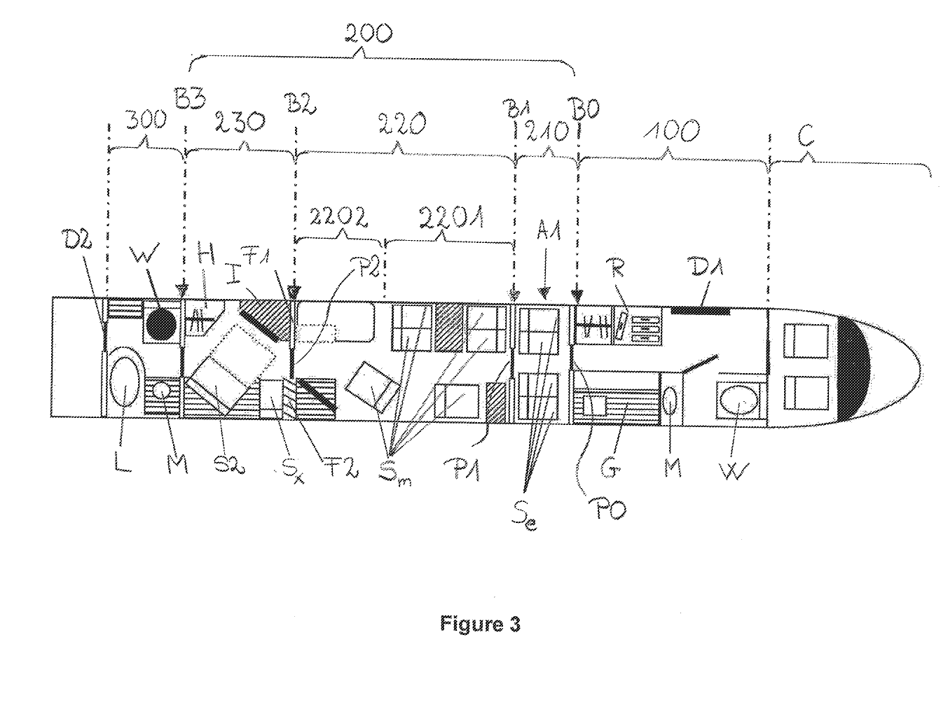

In a first realisation, as illustrated in FIG. 3, an entrance compartment 100, with on the left hand side of the aircraft an entrance door D1 and a crew rest area R, which has variable fixture so that it can be used as storage area or as crew rest, and on the right hand side of the aircraft a toilet W and a gallery G is represented. Adjacent to the entrance compartment, opposite to the cockpit, the first functional area 210 accommodates a first seat row arrangement A1 of 4 seats Sₑ in a 2+2 abreast layout. The seats used would be similar to economy or business class seats in airliners and are certified for take-off and landing. Advantageously, the compartment is separated from the entrance compartment with an entrance bulkhead divider B0 with pocket door P0 and from the second functional area 220 with first bulkhead divider B1 with pocket door P1.

The second functional area 220 is divided in two zones. The first zone 2201 accommodates 6 seats Sₘ, which are certified for take-off and landing. Those seats S are advantageously multi-function seats that can be transformed in full size beds. The seats Sₘ can advantageously swivel in order to facilitate social interactions of the persons to be seated thereon. In this realisation, four seats Sₘ with a table are placed on the left hand side of an aircraft and two seats with swivel are placed on the right hand side. The first zone 2201 is adapted for take/off and landing, for conferencing, for working or for dining. The second zone 2202 is adjacent to the first zone opposite to the cockpit and accommodates a communal zone for social interactions, which has a combination of furniture, i.e. sofa S2, table T, inflight entertainment systems I, side board, among others adapted to the function of the second zone 2202. In the second zone 2202, the sitting furniture is not necessarily certified for take-off and landing.

Next to the second zone 2202, opposite to the cockpit C, a private compartment takes place 230. The private compartment 230 is separated from the second zone 2202, with a second bulkhead divider B2 with pocket doors P2 and from the en suite lavatory compartment 300 with a third bulkhead divider B3 both with pocket doors P3.

The second bulkhead divider B2 which separates the second functional area 220 from the private compartment 230, comprises a first frame F1, a second pocket door P2 that slides into the first frame F1 and a second frame F2. In this realisation, the second Frame F2 supports a plurality of blades that can be rotated in unison from full open to full closed, such achieving the dual function of both privacy protection and light transmission.

The private compartment 230 has a dual function, day and night. During the day time, the area consists of a sofa S2, angled in this realisation at a 45° from the direction of flight. The sofa S2 can sit two persons comfortably. Adjacent to the sofa S2 is a single seat Sₓ that can be folded away when not in use. When in use, it is a comfortable and stylish seat Sₓ, complementary in design and finish. The single seat Sₓ is positioned at a 90° angle from the direction of flight, facing inboard, and/or can be rotated/swivelled through a range of degrees to facilitate interaction with the persons to be seated on the sofa S2. Advantageously, the private compartment 230 further comprises among others an angled closet, inflight entertainment systems I and a side board. During night time, the sofa S2 is transformed into a double bed. The layout of the private compartment 230 is such that the access to the pocket doors P2 and P3, to the closet H as well as to the seat Sₓ is granted whether the sofa is transformed into a double bed or not.

In the en suite lavatory compartment 300, the toilet W is placed 90 degree to the direction of flight, directly facing the washbasin M which comprises water taps. The access door D2 to the baggage compartment, is offset to the left hand side. It will thus be reduced in height due to the curvature of the cabin ceiling. This results in an increased space for a full sized shower L.

Realisation 2—Executive VI+4L

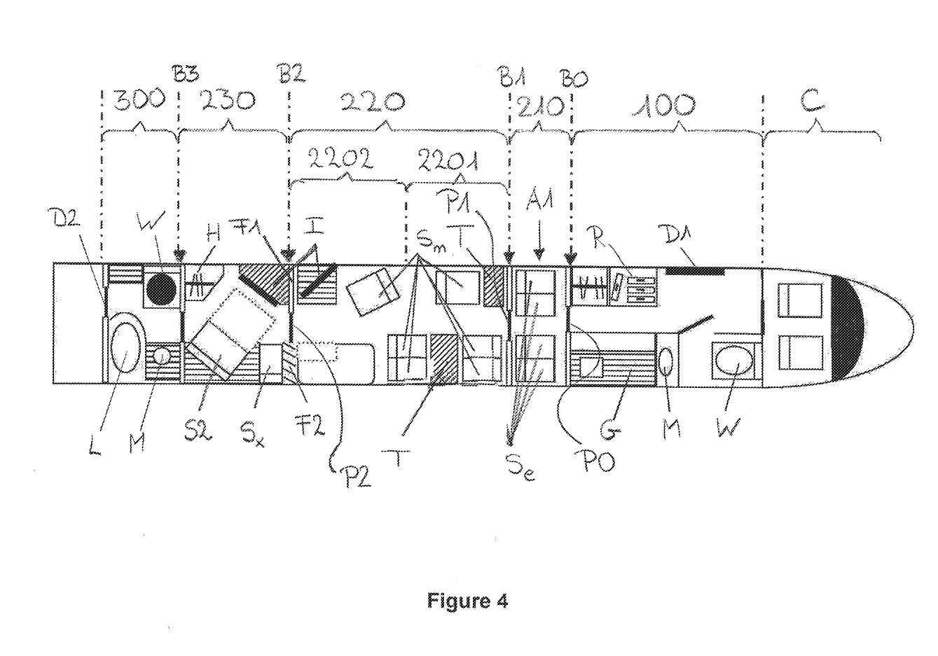

In a second realisation, as illustrated in FIG. 4, an entrance compartment 100, with on the left hand side of the aircraft an entrance door D1 and a crew rest area R, which has variable fixture so that it can be used as storage area or as crew rest, and on the right hand side of the aircraft a toilet W and a gallery G is represented.

Adjacent to the entrance compartment, opposite to the cockpit, the first functional area 210 accommodates a first seat row arrangement A1 of 4 seats Sₑ in a 2+2 abreast layout. The seats used would be similar to economy or business class seats in airliners and are certified for take-off and landing. Advantageously, the compartment is separated from the entrance compartment with an entrance bulkhead divider B0 with pocket door P0 and from the second functional area 220 with first bulkhead divider B1 with pocket door P1.

The second functional area 220 is divided in two zones. The first zone 2201 accommodates 6 seats S, which are certified for take-off and landing. Those seats S are advantageously multi-function seats that can be transformed in full size beds. The seats S can advantageously swivel in order to facilitate social interactions of the persons to be seated thereon. In this realisation, four seats S with a table are placed on the right hand side of an aircraft and two seats with swivel are placed on the left hand side. The first zone 2201 is adapted for take/off and landing, for conferencing, for working or for dining. The second zone 2202 is adjacent to the first zone opposite to the cockpit and accommodates a communal zone for social interactions, which has a combination of furniture, i.e. sofa S2, table T, inflight entertainment systems I, side board, among others adapted to the function of the second zone 2202. In the second zone 2202, the sitting furniture is not necessarily certified for take-off and landing.

Next to the second zone 2202, opposite to the cockpit C, a private compartment takes place 230. The private compartment 230 is separated from the second zone 2202, with a second bulkhead divider B2 with pocket doors P2 and from the en suite lavatory compartment 300 with a third bulkhead divider B3 both with pocket doors P3.

The second bulkhead divider B2 which separates the second functional area 220 from the private compartment 230, comprises a first frame F1, a second pocket door P2 that slides into the first frame F1 and a second frame F2. In this realisation, the second Frame F2 supports a plurality of blades that can be rotated in unison from full open to full closed, such achieving the dual function of both privacy protection and light transmission.

The private compartment 230 has a dual function, day and night. During the day time, the area consists of a sofa S2, angled in this realisation at a 45° from the direction of flight. The sofa S2 can sit two persons comfortably. Adjacent to the sofa S2 is a single seat Sₓ that can be folded away when not in use. When in use, it is a comfortable and stylish seat Sₓ, complementary in design and finish. The single seat S is positioned at a 90° angle from the direction of flight, facing inboard, and/or can be rotated/swivelled through a range of degrees to facilitate interaction with the persons to be seated on the sofa S2. Advantageously, the private compartment 230 further comprises among others an angled closet, inflight entertainment systems I and a side board. During night time, the sofa S2 is transformed into a double bed. The layout of the private compartment 230 is such that the access to the pocket doors P2 and P3, to the closet H as well as to the seat Sₓ is granted whether the sofa is transformed into a double bed or not.

In the en suite lavatory compartment 300, the toilet W is placed 90 degree to the direction of flight, directly facing the washbasin M which comprises water taps. The access door D2 to the baggage compartment, is offset to the left hand side. It will thus be reduced in height due to the curvature of the cabin ceiling. This results in an increased space for a full sized shower L.

Realisation 3—Executive IV+3

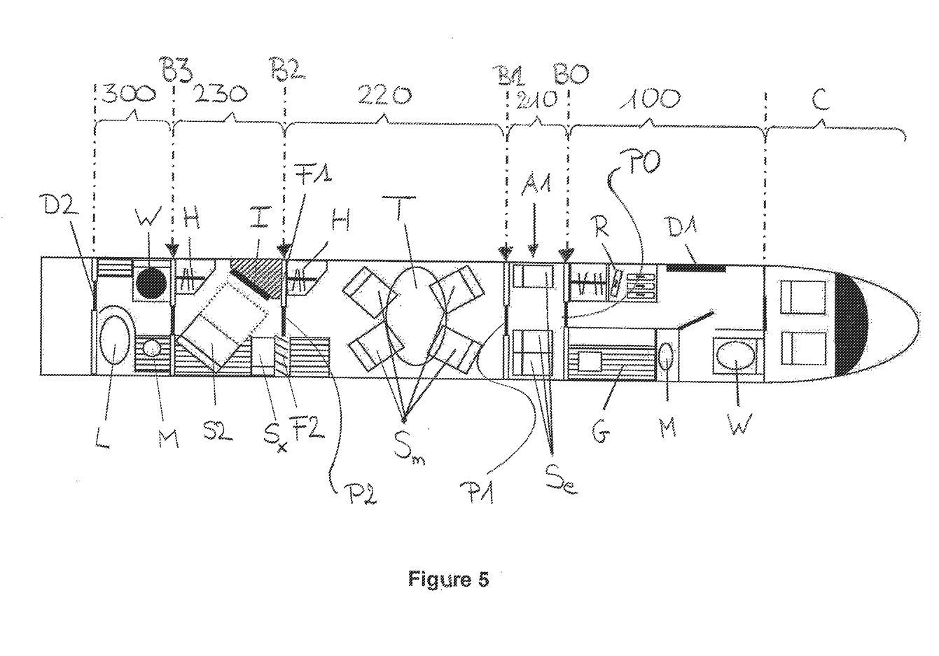

In a third realisation, as illustrated in FIG. 5, an entrance compartment 100, with on the left hand side of the aircraft an entrance door D1 and a crew rest area R, which has variable fixture so that it can be used as storage area or as crew rest, and on the right hand side of the aircraft a toilet W and a gallery G is represented.

The first functional area 210 accommodates a first seat row arrangement A1 of 3 seats Se in a 2+1 abreast layout. The seats used would be similar to economy or business class seats in airliners and are certified for take-off and landing. The compartment is closed with an entrance bulkhead divider B0 and a first bulkhead divider B1 both with pocket doors P0 and P1.

The second functional area 220 accommodates four seats S, which are certified for take-off and landing. Those four seats S are advantageously multi-function seats that can be transformed in full size beds. The four seats S can advantageously swivel in order to facilitate social interactions of the persons to be seated thereon and can be positioned either in a take-off and landing position or in a conferencing/working/dining position, wherein a table can be placed between the four seats S. A closet H and other additional furniture can complete the layout of the second functional area 220.

Next to the second zone 2202, opposite to the cockpit C, a private compartment takes place 230. The private compartment 230 is separated from the second zone 2202, with a second bulkhead divider B2 with pocket doors P2 and from the en suite lavatory compartment 300 with a third bulkhead divider B3 both with pocket doors P3.

The second bulkhead divider B2 which separates the second functional area 220 from the private compartment 230, comprises a first frame F1, a second pocket door P2 that slides into the first frame F1 and a second frame F2. In this realisation, the second Frame F2 supports a plurality of blades that can be rotated in unison from full open to full closed, such achieving the dual function of both privacy protection and light transmission.

The private compartment 230 has a dual function, day and night. During the day time, the area consists of a sofa S2, angled in this realisation at a 45° from the direction of flight. The sofa S2 can sit two persons comfortably. Adjacent to the sofa S2 is a single seat Sx that can be folded away when not in use. When in use, it is a comfortable and stylish seat Sₓ, complementary in design and finish. The single seat Sₓ is positioned at a 90° angle from the direction of flight, facing inboard, and/or can be rotated/swivelled through a range of degrees to facilitate interaction with the persons to be seated on the sofa S2. Advantageously, the private compartment 230 further comprises among others an angled closet, inflight entertainment systems I and a side board. During night time, the sofa S2 is transformed into a double bed. The layout of the private compartment 230 is such that the access to the pocket doors P2 and P3, to the closet H as well as to the seat Sx is granted whether the sofa is transformed into a double bed or not.

In the en suite lavatory compartment 300, the toilet W is placed 90 degree to the direction of flight, directly facing the washbasin M which comprises water taps. The access door D2 to the baggage compartment, is offset to the left hand side. It will thus be reduced in height due to the curvature of the cabin ceiling. This results in an increased space for a full sized shower L.

Realisation 4—Executive IV+6

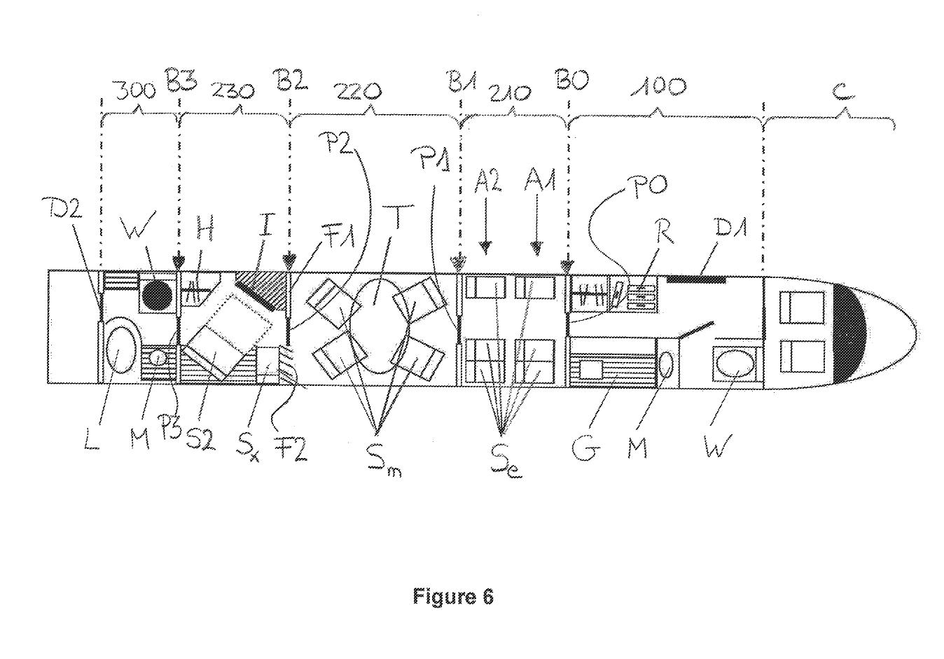

In a fourth realisation, as illustrated in FIG. 6, an entrance compartment 100, with on the left hand side of the aircraft an entrance door D1 and a crew rest area R, which has variable fixture so that it can be used as storage area or as crew rest, and on the right hand side of the aircraft a toilet W and a gallery G is represented.

The first functional area 210 accommodates a first seat row arrangement Al and a second seat row A2 of 3 seats Sₑ in a 2+1 abreast layout. The seats used would be similar to economy or business class seats in airliners and are certified for take-off and landing. The compartment is closed with an entrance bulkhead divider B0 and a first bulkhead divider B1 both with pocket doors P0 and P1.

The second functional area 220 accommodates four seats S, which are certified for take-off and landing. Those four seats S are advantageously multi-function seats that can be transformed in full size beds. The four seats S can advantageously swivel in order to facilitate social interactions of the persons to be seated thereon and can be positioned either in a take-off and landing position or in a conferencing/working/dining position, wherein a table can be placed between the four seats S.

Next to the second zone 2202, opposite to the cockpit C, a private compartment takes place 230. The private compartment 230 is separated from the second zone 2202, with a second bulkhead divider B2 with pocket doors P2 and from the en suite lavatory compartment 300 with a third bulkhead divider B3 both with pocket doors P3.

The second bulkhead divider B2 which separates the second functional area 220 from the private compartment 230, comprises a first frame F1, a second pocket door P2 that slides into the first frame F1 and a second frame F2. In this realisation, the second Frame F2 supports a plurality of blades that can be rotated in unison from full open to full closed, such achieving the dual function of both privacy protection and light transmission.

The private compartment 230 has a dual function, day and night. During the day time, the area consists of a sofa S2, angled in this realisation at a 45° from the direction of flight. The sofa S2 can sit two persons comfortably. Adjacent to the sofa S2 is a single seat Sₓ that can be folded away when not in use. When in use, it is a comfortable and stylish seat Sₓ, complementary in design and finish. The single seat Sₓ is positioned at a 90° angle from the direction of flight, facing inboard, and/or can be rotated/swivelled through a range of degrees to facilitate interaction with the persons to be seated on the sofa S2. Advantageously, the private compartment 230 further comprises among others an angled closet, inflight entertainment systems I and a side board. During night time, the sofa S2 is transformed into a double bed. The layout of the private compartment 230 is such that the access to the pocket doors P2 and P3, to the closet H as well as to the seat Sₓ is granted whether the sofa is transformed into a double bed or not.

In the en suite lavatory compartment 300, the toilet W is placed 90 degree to the direction of flight, directly facing the washbasin M which comprises water taps. The access door D2 to the baggage compartment, is offset to the left hand side. It will thus be reduced in height due to the curvature of the cabin ceiling. This results in an increased space for a full sized shower L.

Realisation 5—Executive IV+6

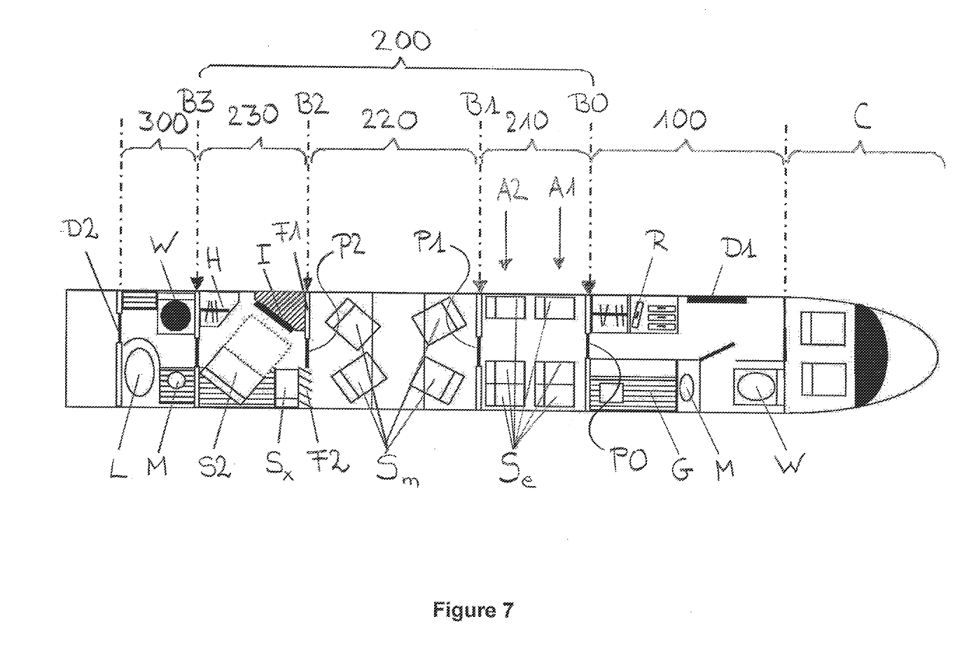

In a fifth realisation, as illustrated in FIG. 7, an entrance compartment 100, with on the left hand side of the aircraft an entrance door D1 and a crew rest area R, which has variable fixture so that it can be used as storage area or as crew rest, and on the right hand side of the aircraft a toilet W and a gallery G is represented.

The first functional area 210 accommodates a first seat row arrangement A1 and a second seat row A2 of 3 seats Sₑ in a 2+1 abreast layout. The seats used would be similar to economy or business class seats in airliners and are certified for take-off and landing. The compartment is closed with an entrance bulkhead divider B0 and a first bulkhead divider B1 both with pocket doors P0 and P1.

The second functional area 220 accommodates four seats S, which are certified for take-off and landing. Those four seats S are advantageously multi-function seats that can be transformed in full size beds. The four seats S can advantageously swivel in order to facilitate social interactions of the persons to be seated thereon and can be positioned either in a take-off and landing position or in a conferencing/working/dining position.

Next to the second zone 2202, opposite to the cockpit C, a private compartment takes place 230. The private compartment 230 is separated from the second zone 2202, with a second bulkhead divider B2 with pocket doors P2 and from the en suite lavatory compartment 300 with a third bulkhead divider B3 both with pocket doors P3.

The second bulkhead divider B2 which separates the second functional area 220 from the private compartment 230, comprises a first frame F1, a second pocket door P2 that slides into the first frame F1 and a second frame F2. In this realisation, the second Frame F2 supports a plurality of blades that can be rotated in unison from full open to full closed, such achieving the dual function of both privacy protection and light transmission.

The private compartment 230 has a dual function, day and night. During the day time, the area consists of a sofa S2, angled in this realisation at a 45° from the direction of flight. The sofa S2 can sit two persons comfortably. Adjacent to the sofa S2 is a single seat Sₓ that can be folded away when not in use. When in use, it is a comfortable and stylish seat Sₓ, complementary in design and finish. The single seat Sₓ is positioned at a 90° angle from the direction of flight, facing inboard, and/or can be rotated/swivelled through a range of degrees to facilitate interaction with the persons to be seated on the sofa S2. Advantageously, the private compartment 230 further comprises among others an angled closet, inflight entertainment systems I and a side board. During night time, the sofa S2 is transformed into a double bed. The layout of the private compartment 230 is such that the access to the pocket doors P2 and P3, to the closet H as well as to the seat Sₓ is granted whether the sofa is transformed into a double bed or not.

In the en suite lavatory compartment 300, the toilet W is placed 90 degree to the direction of flight, directly facing the washbasin M which comprises water taps. The access door D2 to the baggage compartment, is offset to the left hand side. It will thus be reduced in height due to the curvature of the cabin ceiling. This results in an increased space for a full sized shower L.

Realisation 6—Executive IV Curve+4

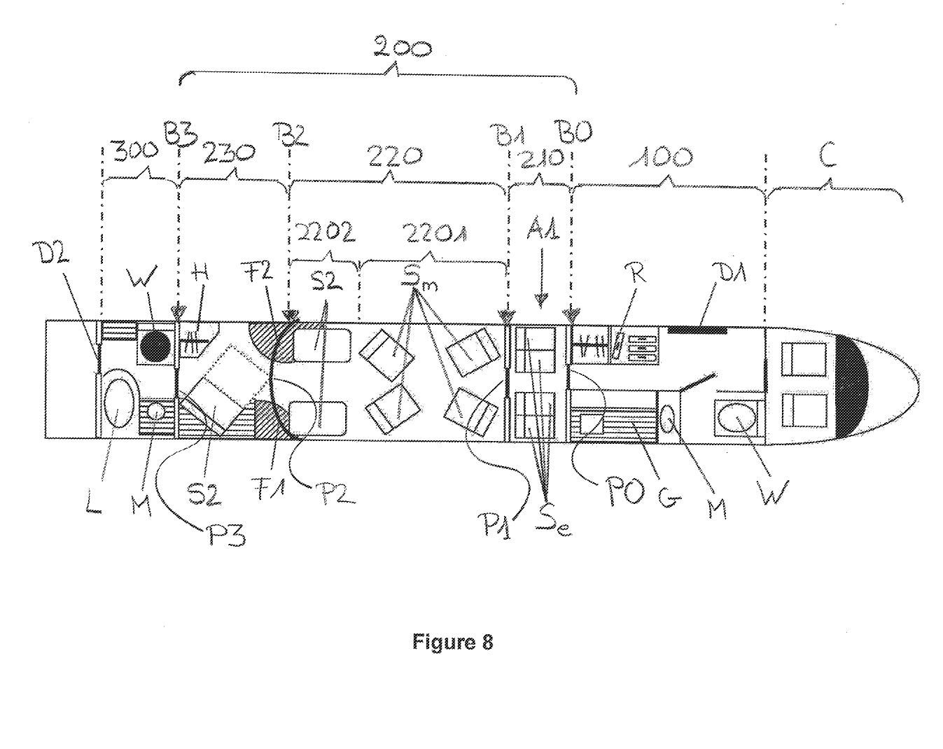

In a sixth realisation, as illustrated in FIG. 8, an entrance compartment 100, with on the left hand side of the aircraft an entrance door D1 and a crew rest area R, which has variable fixture so that it can be used as storage area or as crew rest, and on the right hand side of the aircraft a toilet W and a gallery G is represented.

Adjacent to the entrance compartment, opposite to the cockpit, the first functional area 210 accommodates a first seat row arrangement A1 of 4 seats Sₑ in a 2+2 abreast layout. The seats used would be similar to economy or business class seats in airliners and are certified for take-off and landing. Advantageously, the compartment is separated from the entrance compartment with an entrance bulkhead divider B0 with pocket door P0 and from the second functional area 220 with first bulkhead divider B1 with pocket door P1.

The second functional area 220 is divided in two zones. The first zone 2201 accommodates four seats S, which are certified for take-off and landing. Those four seats S are advantageously multi-function seats that can be transformed in full size beds. The four seats S can advantageously swivel in order to facilitate social interactions of the persons to be seated thereon. The first zone 2201 is advantageously adapted for take/off and landing, for conferencing, for working and for dining The second zone 2202 accommodates a communal zone for social interactions in which two sofas S2 are fitted. In the second zone 2202, the sitting furniture is not certified for take-off and landing.

Next to the second zone 2202, opposite to the cockpit C, a private compartment takes place 230. The private compartment 230 is separated from the second zone 2202, with a second bulkhead divider B2 with pocket doors P2 and from the en suite lavatory compartment 300 with a third bulkhead divider B3 both with pocket doors P3.

The second bulkhead divider B2 which separates the second functional area 220 from the private compartment 230, has a curved shape and comprises a first frame F1, which is curved, a second pocket door P2, adapted slides into the first frame F1 and a second frame F2, which is also curved. In this realisation, the second Frame F2 supports a plurality of blades that can be rotated in unison from full open to full closed, such achieving the dual function of both privacy protection and light transmission.

The private compartment 230 has a dual function, day and night. During the day time, the area consists of a sofa S2, angled in this realisation at a 45° from the direction of flight. The sofa S2 can sit two persons comfortably. Adjacent to the sofa S2 is a single seat Sₓ that can be folded away when not in use. When in use, it is a comfortable and stylish seat Sₓ, complementary in design and finish. The single seat Sₓ is positioned at a 90° angle from the direction of flight, facing inboard, and/or can be rotated/swivelled through a range of degrees to facilitate interaction with the persons to be seated on the sofa S2. Advantageously, the private compartment 230 further comprises among others an angled closet and side boards. During night time, the sofa S2 is transformed into a double bed.

The layout of the private compartment 230 is such that the access to the pocket doors P2 and P3, to the closet H as well as to the seat Sₓ is granted whether the sofa is transformed into a double bed or not.

In the en suite lavatory compartment 300, the toilet W is placed 90 degree to the direction of flight, directly facing the washbasin M which comprises water taps. The access door D2 to the baggage compartment, is offset to the left hand side. It will thus be reduced in height due to the curvature of the cabin ceiling. This results in an increased space for a full sized shower L.

Realisation 7—Executive IV+4

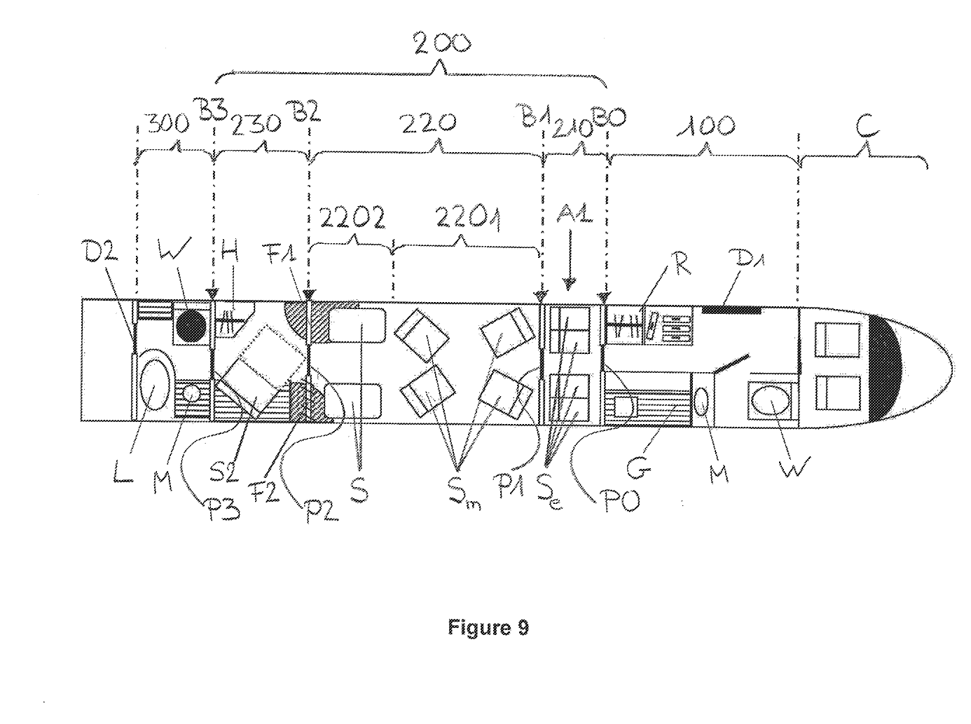

In a seventh realisation, as illustrated in FIG. 9, an entrance compartment 100, with on the left hand side of the aircraft an entrance door D1 and a crew rest area R, which has variable fixture so that it can be used as storage area or as crew rest, and on the right hand side of the aircraft a toilet W and a gallery G is represented.

Adjacent to the entrance compartment, opposite to the cockpit, the first functional area 210 accommodates a first seat row arrangement A1 of 4 seats Sₑ in a 2+2 abreast layout. The seats used would be similar to economy or business class seats in airliners and are certified for take-off and landing. Advantageously, the compartment is separated from the entrance compartment with an entrance bulkhead divider B0 with pocket door P0 and from the second functional area 220 with first bulkhead divider B1 with pocket door P1.

The second functional area 220 is divided in two zones. The first zone 2201 accommodates four seats S, which are certified for take-off and landing. Those four seats S are advantageously multi-function seats that can be transformed in full size beds. The four seats S can advantageously swivel in order to facilitate social interactions of the persons to be seated thereon. The first zone 2201 is advantageously adapted for take/off and landing, for conferencing, for working and for dining The second zone 2202 accommodates a communal zone for social interactions in which two sofas S2 are fitted. In the second zone 2202, the sitting furniture is not certified for take-off and landing.

Next to the second zone 2202, opposite to the cockpit C, a private compartment takes place 230. The private compartment 230 is separated from the second zone 2202, with a second bulkhead divider B2 with pocket doors P2 and from the en suite lavatory compartment 300 with a third bulkhead divider B3 both with pocket doors P3.

The second bulkhead divider B2 which separates the second functional area 220 from the private compartment 230, comprises a first frame F1, a second pocket door P2 that slides into the first frame F1 and a second frame F2. In this realisation, the second Frame F2 supports a plurality of blades that can be rotated in unison from full open to full closed, such achieving the dual function of both privacy protection and light transmission.

The private compartment 230 has a dual function, day and night. During the day time, the area consists of a sofa S2, angled in this realisation at a 45° from the direction of flight. The sofa S2 can sit two persons comfortably. Adjacent to the sofa S2 is a single seat Sₓ that can be folded away when not in use. When in use, it is a comfortable and stylish seat Sₓ, complementary in design and finish. The single seat Sₓ is positioned at a 90° angle from the direction of flight, facing inboard, and/or can be rotated/swivelled through a range of degrees to facilitate interaction with the persons to be seated on the sofa S2. Advantageously, the private compartment 230 further comprises among others an angled closet and side boards. During night time, the sofa S2 is transformed into a double bed. The layout of the private compartment 230 is such that the access to the pocket doors P2 and P3, to the closet H as well as to the seat Sₓ is granted whether the sofa is transformed into a double bed or not.

In the en suite lavatory compartment 300, the toilet W is placed 90 degree to the direction of flight, directly facing the washbasin M which comprises water taps. The access door D2 to the baggage compartment, is offset to the left hand side. It will thus be reduced in height due to the curvature of the cabin ceiling. This results in an increased space for a full sized shower L.

Realisation 8—Executive H+4

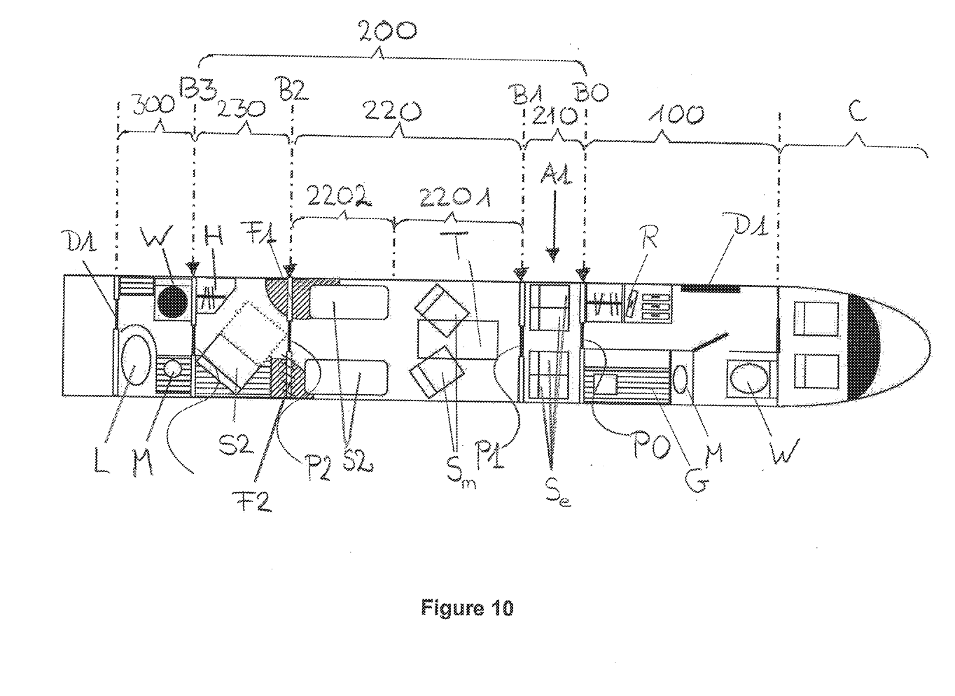

In a eighth realisation, as illustrated in FIG. 10, an entrance compartment 100, with on the left hand side of the aircraft an entrance door D1 and a crew rest area R, which has variable fixture so that it can be used as storage area or as crew rest, and on the right hand side of the aircraft a toilet W and a gallery G is represented.

Adjacent to the entrance compartment, opposite to the cockpit, the first functional area 210 accommodates a first seat row arrangement A1 of 4 seats Sₑ in a 2+2 abreast layout. The seats used would be similar to economy or business class seats in airliners and are certified for take-off and landing. Advantageously, the compartment is separated from the entrance compartment with an entrance bulkhead divider B0 with pocket door P0 and from the second functional area 220 with first bulkhead divider B1 with pocket door P1.

The second functional area 220 is divided in two zones. The first zone 2201 accommodates two seats S, which are certified for take-off and landing. Those two seats S are advantageously multi-function seats that can be transformed in full size beds. The two seats S can advantageously swivel in order to facilitate social interactions of the persons to be seated thereon. The first zone 2201 is advantageously adapted for take/off and landing, for conferencing, for working and for dining and fit a table positioned between the two seats S. The second zone 2202 accommodates a communal zone for social interactions in which two sofas S2 are fitted. In the second zone 2202, the sitting furniture is not certified for take-off and landing.

Next to the second zone 2202, opposite to the cockpit C, a private compartment takes place 230. The private compartment 230 is separated from the second zone 2202, with a second bulkhead divider B2 with pocket doors P2 and from the en suite lavatory compartment 300 with a third bulkhead divider B3 both with pocket doors P3.

The second bulkhead divider B2 which separates the second functional area 220 from the private compartment 230, comprises a first frame Fl, a second pocket door P2 that slides into the first frame F1 and a second frame F2. In this realisation, the second Frame F2 supports a plurality of blades that can be rotated in unison from full open to full closed, such achieving the dual function of both privacy protection and light transmission.

The private compartment 230 has a dual function, day and night. During the day time, the area consists of a sofa S2, angled in this realisation at a 45° from the direction of flight. The sofa S2 can sit two persons comfortably. Adjacent to the sofa S2 is a single seat Sₓ that can be folded away when not in use. When in use, it is a comfortable and stylish seat Sₓ, complementary in design and finish. The single seat Sₓ is positioned at a 90° angle from the direction of flight, facing inboard, and/or can be rotated/swivelled through a range of degrees to facilitate interaction with the persons to be seated on the sofa S2. Advantageously, the private compartment 230 further comprises among others an angled closet and side boards. During night time, the sofa S2 is transformed into a double bed. The layout of the private compartment 230 is such that the access to the pocket doors P2 and P3, to the closet H as well as to the seat Sx is granted whether the sofa is transformed into a double bed or not.

In the en suite lavatory compartment 300, the toilet W is placed 90 degree to the direction of flight, directly facing the washbasin M which comprises water taps. The access door D2 to the baggage compartment, is offset to the left hand side. It will thus be reduced in height due to the curvature of the cabin ceiling. This results in an increased space for a full sized closed position.

1.-25. (canceled)

26. An interior configuration of a corporate aircraft, comprising
an entrance compartment (100), which is situated directly next to a cockpit (C) of the aircraft;
a passenger compartment (200) which is adjacent to the entrance compartment (100) opposite to the cockpit (C) further comprising a first functional area (210) which is adjacent to the entrance compartment (100), and a second functional area (220) which is next to the first functional area (210);
an en suite lavatory compartment (300) which is adjacent to the passenger compartment (200) opposite to the entrance compartment (100);
the interior configuration being further characterised in that
the first functional area (210) is configured to be used as a support staff cabin, and comprises at least one seat (Sₑ) in a first seat row arrangement (A1) wherein the at least one seat (Sₑ) is similar to economy or business class seats in airliners and is certified for take-off and landing;
the second functional area (220) is used as a high-end cabin, wherein the second functional area (220) is configurable from at least a first configuration to at least a second configuration and comprises at least one first seat (Sₘ) certified for take-off and landing and at least one second seat (Sₓ) not certified for take-off and landing, wherein the at least one first seat (Sₘ) is a multi-function fully berthable seat; and
the passenger compartment further comprises a first bulkhead divider (B1) between the first functional area (210) and the second functional area (220) which comprises a first pocket door (P1) and first mounting means for allowing the first pocket door (P1) to move between an open and a closed position.

27. The interior configuration of claim 26, wherein
in the first functional area (210) the first seat row arrangement (A1) comprises a gangway and additional seats (Sₑ) arranged in a configuration selected in the following: one plus one, two plus one, two plus two and three plus one seats wherein the additional seats (Sₑ) are similar to economy or business class seats in airliners and are certified for take-off and landing.

28. The interior configuration of claim 27, wherein
The first functional area (210) further comprises a second seat row arrangement (A2), whereby the seats (Sₑ) in the second row are arranged behind the at least one seat and the additional seats, wherein the seats (Sₑ) in the second seat row are similar to economy or business class seats in airliners and are certified for take-off and landing.

29. The interior configuration of claim 26, wherein
the second functional area (220) further comprises
a private compartment (230) comprising a convertible sofa (S2) positioned at a predetermined angle, comprised between 5° and 45°, from the direction of flight; and
a second bulkhead divider (B2) between the private compartment (230) and a remaining part of the second functional area (220), which defines a doorway for passage of people, and comprises
a first frame (F1), which accommodates a second pocket door (P2), with second mounting means for allowing the second pocket door (P2) to move between an open and a closed position; and
at least one second frame (F2) positioned next to the first frame (F1) and enclosing at least one panel.

30. The interior configuration of claim 29, wherein
the convertible sofa (S2) comprises
at least two fully berthable multi-function seats positioned next to each other, each of the at least two fully berthable multi-function seats being configurable either individually, or in unison from an upright position, through a relax position to a bedding position.

31. The interior configuration of claim 29, wherein
the at least one second frame (F2) further comprises
a plurality of blades, whereby one of the at least one second frame (F2) supports a plurality of blades; and
fixation means arranged to mount the plurality of blades onto the one of the at least one second frame (F2).

32. The interior configuration of claim 31, wherein
at least a spindle fixed to and extending beyond the at least one of the plurality of blades (220) at opposite ends thereof, the spindle at one end of each blade being fixed with the fixation means onto the at least one delimiting frame (210).

33. The interior configuration of claim 29, wherein
the at least one second frame (F2) encloses at least one perforated panel.

34. The interior configuration of claim 29, wherein
the first frame (F1), the at least one second frame (F2) and the second pocket door (P2) are horizontally curved.

35. A crew rest area (R) configurable from
at least a first disposition, wherein a berthable seat, a foldable table, modern appliances and light fixtures are fitted so that this area is used as a crew rest; to
at least a second disposition, wherein the space is organized into a wardrobe/storage volume with wardrobe/storage accessories;
wherein the crew rest area (R) further comprises
quick-change fixation means configured to easily fit or unfit the berthable seat, the foldable table, the modern appliances and the light fixtures or the wardrobe/storage accessories in the crew rest area (R).

36. The crew rest area (R) of claim 35, further configurable into
a third disposition, wherein a space is organized to position and store airliner type trolleys, cabinets for additional equipment as may be needed from time to time, depending on operational requirements.

37. The interior configuration of claim 26, wherein the entrance compartment (100) comprises the crew rest area (R).

38. An en suite lavatory compartment (300) comprising
a toilet (W);
a washbasin with water taps;
a full size shower (L); and
an access door (D2) so that direct access to a luggage compartment is granted;
wherein the access door (D2) is offset of the aircraft centre line and is outside of the full size shower (L).

39. The interior configuration of claim 26, comprising
the en suite lavatory compartment (300).

40. An aircraft comprising the interior configuration of claim 26.
